(19) United States
(12) Patent Application Publication
(10) Pub. No.: US 2004/0174798 A1
(43) Pub. Date: Sep. 9, 2004

(54) Data copy-protecting system for creating a copy-secured optical disc and corresponding protecting method

(76) Inventors: Michel Riguidel, Paris (FR); Thierry Beuzit, Paris (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/470,748

(22) PCT Filed: Feb. 5, 2002
(86) PCT No.: PCT/FR02/00438

(30) Foreign Application Priority Data
Feb. 9, 2001 (FR) 01/01808

(51) Int. Cl. G11B 7/00

(52) U.S. Cl. 369/111

(57) ABSTRACT

The invention relates to a system for protection against the copying of information for the creation of a protected optical disk.

The system comprises, at the premises of the publisher of an application (12), a creation software assembly (10) carried by an auto-protected optical disk comprising an assembly of protection elements allowing the publisher to insert into the application a protection file manifesting his strategic choices of protection. The resulting assembly is transcribed onto a transport disk (CD-R1) so as to be sent to the duplicator's premises. The latter, with the aid of a pre-mastering software assembly (20), reconstructs the content of the definitive disk comprising a protection zone in two parts, in the form of two disks (CD-R2, CD-R3) respectively containing the data of the main track together with the first part of the protection zone and of the second part.

The invention applies to the creation of optical disks protected against copying.

The present invention concerns a system for protection against the copying of information for the creation of a protected optical disk of the type comprising at least one main spiral track and a protection zone having two parts of the same size, one at least of which belongs to the main track. It also concerns a corresponding protection process.

Numerous techniques have been developed, in particular in the last few years, for preventing the illegal copying of optical disks. One of the simplest of them consists in burning an anti-copying protection code at a predetermined place on the disk, during its manufacture. This predetermined place is such that numerous copying techniques cannot reproduce this place on the disk. Players are made so-as to reject disks having no protection code at the right place. However, it is obvious that any device made or modified so as to read all the data of a disk can copy the disk, including its protection code, and the illegal copy obtained is exactly similar to the original disk.

Another known technique is the SCMS method (“Serial Copy Management System”) according to which a disk carries an SCMS code which authorizes or otherwise copying. A disk having an SCMS code authorizing copying can be copied but the copying device changes the SCMS code for a code prohibiting any other copying. However, as is apparent, this technique suffers from the same drawback as before when all the data of the disk are copied as they stand.

Other relatively sophisticated techniques have been conceived for remedying the unauthorized copying problems. Most of them involve the use of a “signature” or specific imprint on the disk. This may consist of a variation of certain parameters of etching on the disk, such as shape of the marks (depth, width, length), introduction of an asymmetry of the marks, wobulation of the track at particular frequencies, etc. These variations constitute the signature to be searched for and cannot be reproduced by standard writers such as CD-R writers. However, it is necessary that the disk players detect these variations and this is not generally possible with standard players. A variant of this method makes it possible to create ambiguous code words capable of being read with different values when the disk is played several times in succession on standard players.

A different technique consists in deliberately damaging or destroying turns or sectors of the original disk whose addresses can be encrypted so as to construct a code identifying the disk burnt onto the latter. However, a drawback of this type of technique is that it requires that the user of the disk be authenticated by a more or less complex access cue that the user will have to introduce as a key to obtain access to the content of the disk. This cue often has to be requested from an entitlement station. This technique therefore imposes appreciable constraints. Another drawback of such methods of recognizing damaged parts is that it makes it possible to hide only a small quantity of data, which therefore may easily be incorporated into the body of the software. Another drawback is that the writing of such marks is structurally within the scope of commercial disk writers, the only obstacle to the recopying of the disks being that the software for controlling these writers is unsuitable for the management of such marks, errors or omissions. A modification of one of the items of control software (at the level of the user processor or of the internal software of the writer) would however be sufficient to recopy these disks. It may be noted here that the damaging of the disk may ultimately consist in the outright omission of certain sectors.

To attempt to remedy certain of these drawbacks and strengthen the security of anti-pirating systems with hidden codes, techniques have been developed based on an interrupted spiral or on separate zones between which the data are distributed in such a way as to prohibit continuous recording of executable data. Such techniques may, however, entail a reduction in density of the information on the disk or sometimes the use of nonstandard players.

A seemingly more promising route has been outlined by providing a disk comprising a continuous main spiral or track between whose turns is interposed a secondary spiral piece, the standard pitch or spacing of the tracks of a conventional optical disk being retained. A method of authentication then consists in “recognizing” the secondary spiral only by verifying the presence of specific identifying or address codes which are not located on the main track. However, this technique does not efficiently make the most of the major benefit of employing a zone which is not easily reproducible by a standard writer.

It has recently been proposed to remedy these drawbacks and to make the most of the benefit of the existence of such a zone which makes it possible to eliminate conventional copying with the aid of standard writers, by virtue of the recognition of the physical presence of a two-part protection zone.

This particularly beneficial solution envisages an optical disk protected against copying of the type comprising at least one main spiral track onto which are burnt information marks laid out in sectors whose addresses are substantially sequential along the track, and a protection zone having two parts of the same size, each including a series of sectors designated by identical addresses for each part, the information stored in this zone being distributed between the sectors of the two parts and each sector of the zone furthermore carrying identifying information characteristic of the part to which the sector belongs, one of the parts at least belonging to the main track.

A protection subprogram makes it possible to check the presence and the makeup of said protection zone and to use the information stored in this zone, the information elements of said subprogram being recorded on the disk.

The advantage of the existence of a two-part protection zone is particularly important if one of the parts is disposed on a secondary track interposed partially between turns of the main track. Since in this way it becomes impossible for a standard writer to produce a disk with two tracks and any illegal copying of a disk can be rendered very difficult by verifying the physical structure of the disk read. Moreover, even a modification of the control electronics of industrial equipment for manufacturing disk masters would then not allow these disks to be duplicated.

To further improve protection against copying, the aim of the invention is to make the most of the physical modifications of the abovementioned disk by adding thereto a software part allowing a client application to use these physical modifications to best effect, while greatly complicating the work of a pirate and making it necessary to repeat almost all of this circumvention work for each title.

The invention therefore relates to a system for the creation of such a protected optical disk and is characterized in that this system comprises:

a protection creation software assembly for allowing the creation, at the premises of the publisher of an application intended to be carried by said disk, of a protection file on the basis of protection elements of said software assembly that are selected by the publisher and of data and parameters chosen by the publisher;

a means of transport comprising said application and said protection file as well as the location of the corresponding files on the protected disk, according to a tree determined by the publisher;

a pre-mastering software assembly for, at the premises of the disk duplicator and on the basis of the information contained in said transport means, determining and generating the content of the two parts of said protected disk; and

means of storage respectively of the information of the main track, together with the first part of the protection zone, and of the second part of this zone for the effecting by the duplicator of the subsequent operations of mastering and duplication of the protected disk.

By virtue of this system which implements a certain number of alterable software protection elements, one prevents the production of a generic patch (or software adaptation, but the word “patch” is generally used in specialized environments and will therefore be employed subsequently) and one complicates the analysis and the understanding of the protection implemented. Other characteristics of the invention are defined subsequently in the description.

According to another aspect of the invention, there is provided a process for protection against the copying of information recorded on a protected optical disk of the type comprising at least one main spiral track onto which are burnt information marks laid out in sectors whose addresses are substantially sequential along the track, and a protection zone having two parts of substantially the same size, each including a series of sectors designated by identical addresses for each part, each sector of the protection zone including identification information characteristic of the part to which it belongs and one of the parts at least belonging to said main track, said process being characterized in that it consists in creating a protection file on the basis of software protection elements selected during the creation of said file and in recording said file in the protection zone of the disk.

Other characteristics of the process are defined subsequently in the description.

The invention will be better understood and other characteristics and advantages will become apparent with the aid of the description hereinbelow and of the appended drawings in which:

FIG. 1 is a representation in linear form of the spiral turns of a protected disk;

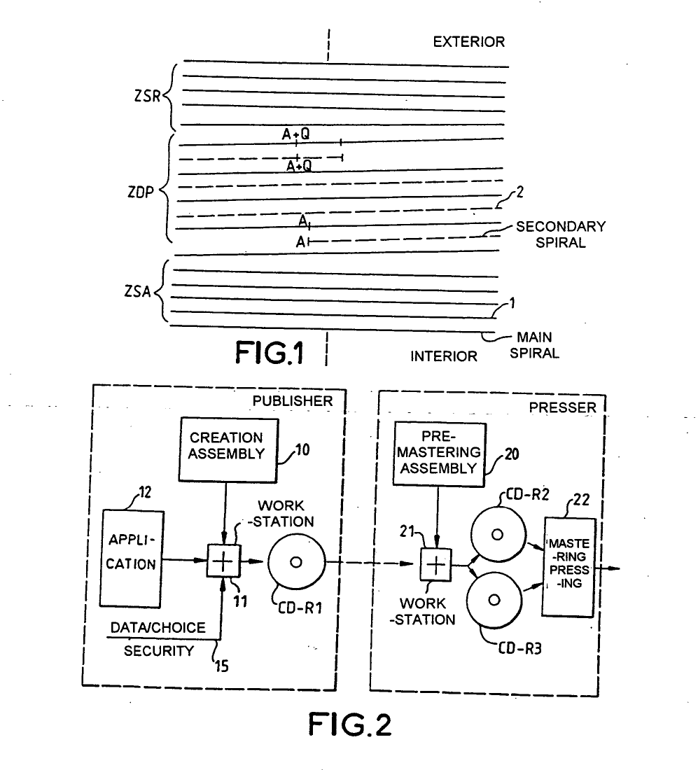

FIG. 2 is a diagram of the system according to the invention between publisher and duplicator for the creation of a protected disk;

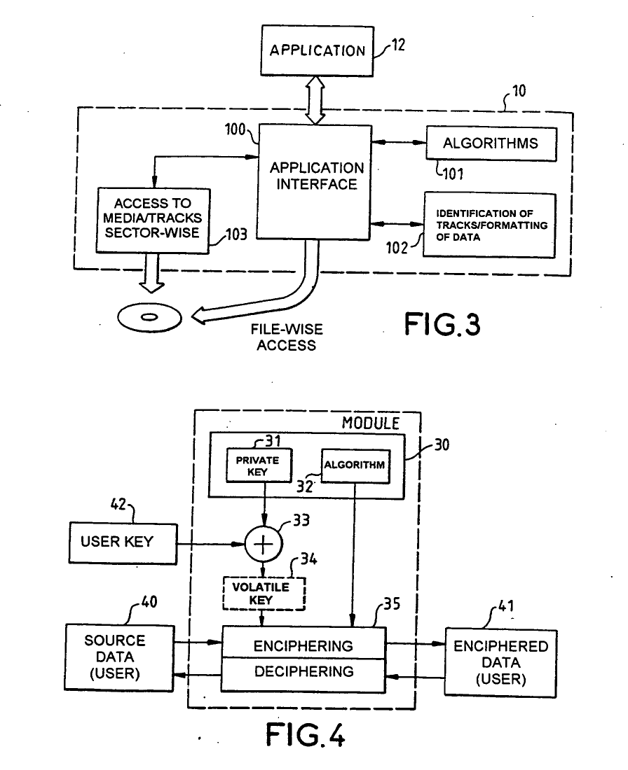

FIG. 3 is a diagram of the software architecture of the software assembly of the system according to the invention;

FIG. 4 is a schematic of the enciphering/deciphering protection element.

Represented in FIG. 1 is a preferential form of protected disk, in which each turn (or loop) of a spiral track is represented by a segment stretching from the extreme left to the extreme right of the figure. Likewise, indicated towards the bottom of the figure is the interior of the disk, where a main spiral track 1 begins, and the exterior of the disk where this track finishes.

The main track 1 is a continuous spiral track disposed over the whole of the useful part of the disk and whose sectors have, in a conventional manner, addresses ordered substantially sequentially along this track. A secondary track 2 is interposed between successive turns of the main track, in such a way that the pitch of the track remains, substantially in all the zones of the disk, constant and equal to the standard pitch customarily used in conventional optical disks, such as CD- or DVD-ROM disks. The two-part zone in which the two tracks coexist and in which the same addresses A to A+Q are used on the two parts or tracks is called the “protection zone” ZDP. The association of two sectors having the same address respectively on the main track 1 and on the secondary track 2 will be called a “register”. As will be seen, each sector of the protection zone comprises an item of information identifying the track on which it is located. The part of the protection zone belonging to the main track will be denoted pA and the part of the zone ZDP belonging to the secondary track will be denoted pB.

It is clear that a standard player performing successive reads of a given address always under the same conditions has every chance statistically of always reading the sector of the same part. Recognition of the physical structure of the disk, which must make it possible to differentiate a two-track original disk from a one-track copy, therefore consists in performing a series of reads of a ZDP sector from a ZSA zone of the main track where the addresses are lower than the sought-after address (there is then every chance of reading the sector on the secondary track that shows up first) followed by a series of reads of the same address from a ZSR zone where the addresses are higher than the sought-after address (there is then every chance of reading the sector on the main track). Thus, if after these two series of reads, the two different items of identifying information of the ZDP zone have been found, it is possible to conclude therefrom that one is indeed in the presence of an original disk with two tracks pA and pB.

However, this physical protection against copying may be deemed insufficient and should be supplemented with software protection, which makes the most of these physical features in order to differentiate an original disk from a copy.

The software protections of applications (games, encyclopedias, etc.) are the subject of attacks of several types of pirates depending on whether they act for recreational reasons (to understand and “break” an item of software by virtue of their skill and then to publish), economic reasons (counterfeiting and pressing of de-protected disks) or anarchic reasons (to disseminate the patch of an application as widely as possible without explanation as regards the method).

The most dangerous attack in respect of a system for protecting against copying is the creation of a patch and its dissemination. Now, it is clear that it is impossible to prevent the creation of a patch for a given application; however, this task may be made expensive and difficult. If, furthermore, the protection is modified for each application, making it necessary to repeat the task in question, it is no longer possible to automate the generation of the patch, making it possible to circumvent the protection, and the pressing of de-protected disks.

The objectives of the invention are therefore to prevent the production of a generic patch by rendering the system alterable and in large measure to complicate the analysis and the comprehension of the protection.

To do this, the system according to the invention is based on the twofold principle of leaving the publisher of an application the job of defining his protection policy and of introducing randomness into the construction of the protection assembly.

The protection system according to the invention intervenes both at the premises of the publisher of an application to be protected and at the premises of the duplicator, or disk presser, who participate in the writing of the data after transformation. FIG. 2 is an overall diagram of the protection system and of its implementation for the creation of a protected optical disk.

The publisher starts from his functional application 12 and decides with regard to sensitive data that he wishes to conceal, to the level of protection to be adopted, to the types of sanction to be applied in case of effecting of pirate copies or of attempted intrusions, and to deterrence/diversion/decoying scenarios intended to dissuade and to thwart the pirate in his search. He implements this protection strategy by using on his workstation a series of software tools provided by a creation software assembly 10 which make it possible to insert the protections into his application, to automatically generate the algorithms and keys for protecting the data as a function of the security level that he has chosen, to conceal data chosen in the protection zone and to implant and position decoys.

The introduction of the strategic choices made by the publisher is shown diagrammatically by the input 15. The system then creates a protection file implementing these choices which is the representation of the protected zone. On his workstation the publisher creates the tree of his application, making unrestricted use of his files, and puts the protection file into this tree (at the place and under the name that he specifies). The application with the protections thus implanted and positioned is transferred onto a transport or transfer medium CD-R1 which is preferably a recordable optical disk. This medium is forwarded to the duplicator/presser who then on his workstation 21 performs the pre-mastering operations which consist in transforming, on the basis of a pre-mastering software assembly 20, the data of the medium CD-R1 into the form required for proceeding with the mastering and pressing of the final protected disk. These data may for example be recorded on two recordable optical disks CD-R2 and CD-R3 that respectively contain the data to be written on the main track of the final disk and on the secondary track. They may also be transferred by any other means, protected or otherwise, of storing and/or of transferring information (e.g.: datalink, tele-communication with or without encryption, etc.).

The creation software assembly of the system according to the invention is described by defining a certain number of protection elements and by stringing these elements together. The software assembly intervenes both during creation at the premises of the publisher, where it generates a protection file which is the representation of the content of the protection zone ZDP of the protected final disk, and during pre-mastering at the premises of the presser and also during usage of the application protected by a user client of the publisher.

The software assembly comprises a certain number of components according to an architecture represented in FIG. 3 applicable to any client application of the system.

These components include an interface 100 with the client application, a component 103 for access to media 13 sector-wise as well as to the two-part protection zone, a component 102 for management of the track identification procedure and for data formatting and a library 101 containing all the unprotected algorithms (calculation of verifying codes of the CRC/Cyclic Redundancy Code type, data matrixing, enciphering algorithms, etc.). These components are copied into the tree of the application by the publisher at the place and under the name that he chooses.

Among the protection elements available in the creation software assembly of the system according to the invention, a first of them consists of the variable positioning of the information identifying parts/tracks in the protection zone. This protection element includes a function for calculating the position of the identifying information within each sector considered as a function of the relative position of the sector in the protection zone ZDP and of the absolute position of the start of this zone. It is for example possible to conceive of various transformation laws for going from the value of the absolute position of the sector to a value lying between zero and the number N of bytes of the sector, which will constitute the position of the identifying information or of the byte containing it in the sector.

A notable advantage of this variable positioning is that the position of the identifying information changes as soon as the start position of the protection zone changes, this having to be the case when the content of the disk is changed (the publisher changes his choices).

Another protection element consists in concealing data chosen by the publisher, in particular data deemed by him to be sensitive. Specifically, the aim is to complicate the recovery of data outside of the application. To do this, the system makes it possible to implant data, distributing them over the tracks pA and pB of the protection zone after having transformed them. For example, for each register of the protection zone, a random number k is drawn so as to effect a matrixing of the data received: the initial data are regarded as a set of matrices of size k plus a surplus, if any, and in each matrix the rows are permuted with the columns while retaining the surplus, if any, as is. Half the final data is then written to pA and half to pB while adding thereto the appropriate track identifying information and in the desired position.

The creation software assembly can also propose the implantation of decoys as protection element. The aim of a decoy is to make one believe that the application is operating normally for as long as possible, so as to make it very difficult to search for the origin of the abnormal effects that the decoy will induce. The implantation of a decoy is done in both sectors of a register in such a way that the reading of a single part/track of the protection zone induces apparently correct but different functioning of the application, at least for a certain time, and worse as appropriate.

Another protection element tending to make it complex to recover the data in the protection zone consists in enciphering/deciphering data according to a security level chosen by the publisher. Several security levels are in fact available and it is the publisher who must choose the right compromise between security and speed since the safer an algorithm, the slower it is as a general rule. Preferably, the first level consists of straightforward scrambling. For other security levels, the creation software assembly employs several algorithms with comparable execution times and, within the level selected, it randomly chooses an algorithm itself. The associated enciphering keys are created by the system and managed by the application. To protect these application package keys, the system creates a private enciphering key that it manages itself. An enciphering module contains the security level chosen, the enciphering/deciphering algorithm (or more precisely its identifier) and a private key. The application package key is known to the application alone that loads/unloads it from the module during enciphering/deciphering operations.

This is shown diagrammatically in FIG. 4 wherein is recognized a module 30 with the private key 31 and the associated algorithm 32, the application package key 42 which, associated at 33 with the private key, generates the volatile key 34 required by the algorithm 30 for the enciphering/deciphering operations 35 making it possible to go from the source data 40 of the application to the enciphered data 41 and vice versa.

Another important protection element consists of a series of anti-intrusion measures. These measures have the object of preventing the analysis and comprehension of the manner of operation of the application essentially through the use of debuggers (for example: SoftICE, registered trade mark) and of checking that the application or its data have not been modified.

A first measure consists in prohibiting, as soon as the application is run, the use of known debuggers such as SoftICE. These measures additionally include a function of detection on request (from the application) of the presence of a debugger. The principle is to multiply up the number of checks at various places so as to complicate circumvention.

A function for verifying the integrity of the codes with the aid of the calculation of CRCs is also provided. It is in particular possible to calculate the CRC 16 of the various components of the original system and then to verify these codes during the loading of these components. A function of verification of signature of the disk on data stored in the protection zone may also be provided. It consists for example in calculating the CRC 32 of the useful data of a sector during the creation of a disk and in verifying this value during use.

A function of detection of incorrect execution time for predetermined functions is also provided.

These anti-intrusion measures culminate in counter-measures triggered when at least one anomaly is detected. These counter-measures comprise the placing of the system in various states according to the nature and the gravity of the anomaly detected. The unstable state is manifested by the fact that a requested reading of a sector causes the reading of another sector (incorrect data), or reading fails because one has left the protection zone, or reading does not happen and inconsistent data are returned instead. This unstable state may be triggered, without warning to the application, by the detection of the presence of a debugger during initialization or following the use of the signature verification function.

The critical state is manifested by the halting without notice of the system during any subsequent action entailing reading from the protection zone. This critical state may be triggered by a poorly performed initialization or by the detection of the presence of a debugger by the detection on request function.

The disabled state is manifested by the immediate disabling of the system without information or notice. It is triggered when the integrity of the codes is not complied with or in case of inconsistent execution time.

These protection elements do not provide shelter from a security flaw at the publisher's premises. Thus, there is provision for the system to be auto-protected and the creation software assembly is therefore supplied to the publisher on an optical disk itself protected by the system according to the invention.

When the protection file has been created by the publisher and implanted in the tree of the application which is transcribed onto the transport disk CD-R1, it is then necessary to carry out the pre-mastering operations for rewriting the data for the disks CD-R2 and CD-R3 such that they will be present respectively on the main track and the secondary tracks of the protected final disk. It is the role of the pre-mastering software assembly to generate images of data of these disks. This assembly comprises in particular a function for calculating the start of the two-part protection zone, a function for calculating the position of the track identifying information and a sector write function for placing said identifying information at the position calculated for said sector.

It should be noted that the creation software assembly intervenes in the pre-mastering software assembly, one of the pre-mastering operations being to replace the creation software assembly with a usage software assembly that comprises similar components renamed allowing access to the functions of the creation assembly that are required in the usage mode, which mode allows the protected application to use the protection.

The function for calculating the start of the protection zone consists in searching through the sectors read from the data of the transport disk CD-R1 for a sector of the main track pA that contains start of protection zone information for the track pA and that is followed immediately by a sector of the track pB that contains the start of zone information for this second part and in verifying that these conditions occur just once and that the start of protection zone is situated at distances from the start and from the end of the main track that are greater than predetermined values.

As far as the function for calculating the position of the part/track identifying information is concerned, it is of the same type as that described earlier in respect of the creation software assembly.

The preferred solution for carrying the data obtained after pre-mastering consists of conventional recordable optical disks CD-R2 and CD-R3.

Of course, the assemblies and functions described above are supplemented with conventional functions of initialization, of writing and of reading of data or of file loading/unloading.

It is clear that the invention applies preferentially to a protected optical disk of the type with physically separate double track. However, the solution with protection zone having two parts on the same track is not excluded, by means of the necessary adaptations.

It is also clear that the description hereinabove makes it possible at the same time to define a corresponding process for protection against the copying of information using these same principles of protection.

Of course, the principles of the system and of the process according to the invention will remain valid, even though other protection elements may be conceived and added.

1. A system for protection against the copying of information for the creation of a protected optical disk of the type comprising at least one main spiral track onto which are burnt information marks laid out in sectors whose addresses are substantially sequential along the track, and a protection zone (ZDP) having two parts of substantially the same size, each including a series of sectors designated by identical addresses for each part, each sector of the protection zone including identification information characteristic of the part to which it belongs and one of the parts at least belonging to said main track, said system being characterized in that it comprises:
a protection creation software assembly (10) for allowing the creation, at the premises of the publisher of an application (12) intended to be carried by said disk, of a protection file on the basis of protection elements of said software assembly that are selected by the publisher and of data and parameters chosen by the publisher;
a means of transport (CD-R1) comprising said application and said protection file as well as the location of the corresponding files on the protected disk, according to a tree determined by the publisher;
a pre-mastering software assembly (20) for, at the premises of the disk duplicator and on the basis of the information contained in said transport means, determining and generating the content of the two parts of said protected disk; and
means of storage (CD-R2, CD-R3) respectively of the information of the main track, together with the first part of the protection zone, and of the second part of this zone for the effecting by the duplicator of the subsequent operations of mastering and duplication of the protected disk.

2. The system as claimed in claim 1, characterized in that said creation software assembly comprises an element for protection by variable positioning of the part identifying information including a function of calculating the position of the identifying information within the sector considered as a function of the relative position of the sector in the protection zone and of the absolute position of the start of said zone.

3. The system as claimed in one of claims 1 and 2, characterized in that said creation software assembly comprises an element for protection by concealment of data chosen by the publisher including a function of matrixing the data received for each register, consisting of two associated sectors of the protection zone, on the basis of a random value k and of writing of the final data distributed between the two parts of said protection zone.

4. The system as claimed in claim 3, characterized in that said matrixing consists, considering the data received as a set of matrices of size k plus a surplus, if any, in permuting the rows with the columns of said matrices while preserving the surplus, if any, as is.

5. The system as claimed in any one of claims 1 to 4, characterized in that said creation software assembly comprises an element for protection by implantation of decoys into the two associated sectors of a register of the protection zone in such a way that the reading of just a single part of the protection zone induces apparently correct but different functioning of the application.

6. The system as claimed in any one of claims 1 to 5, characterized in that said creation software assembly comprises an element of protection by enciphering/deciphering of data according to a level of security chosen by the publisher.

7. The system as claimed in claim 6, characterized in that said element for protection by enciphering/deciphering comprises:
a collection of enciphering/deciphering algorithms assigned to the various levels of security, an algorithm of the level chosen by the publisher being selected randomly by the system itself;
a function for creating a private key, said algorithm and its private key being stored in an enciphering module in the two associated sectors of a register of the protection zone;
a function for creating an application package key by the publisher on the basis of the data of said enciphering module, said application package key being known to the application alone;
a function of data enciphering/deciphering on the basis of said module and of said application package key.

8. The system as claimed in any one of claims 1 to 7, characterized in that said creation software assembly comprises an element for protection by anti-intrusion measures including at least one of the following measures:
a function for detecting on request debugger presence;
a function for verifying the integrity of the codes on the basis of the calculation of CRCs;
a function for verifying a signature of the disk on data stored in said protection zone;
a function of detecting incorrect execution time for specified functions of said creation software assembly;
counter-measures triggered when at least one of said functions of the anti-intrusion measures detects an anomaly.

9. The system as claimed in claim 8, characterized in that said counter-measures comprise the placing of the system either in an unstable state where the data requested are not read or are modified without warning, when the presence of a debugger is detected on initializing the system or upon using the signature verification function, or in a critical state where any subsequent action entailing reading from the protection zone causes the system to halt without notice, when the presence of a debugger is detected by said detection on request function, or in a disabled state where the system is disabled without information or notice, when the function for verifying the integrity of the codes or the function for detecting execution time detect an anomaly.

10. The system as claimed in any one of the preceding claims, characterized in that said protection file includes the components (100 to 103) of said creation software assembly.

11. The system as claimed in any one of the preceding claims, characterized in that said creation software assembly (10) is carried by an optical disk which is itself protected by the system according to any one of the preceding claims.

12. The system as claimed in any one of the preceding claims, characterized in that said pre-mastering software assembly comprises means for generating an image of the data to be stored in said respective means of storage, said means of generating images including a function for calculating the start of the two-part protection zone, a function for calculating the position of the part identifying information, identical to that of said creation software assembly, and a function for writing a sector so as to place said identifying information at the position calculated in each sector to be burnt in said images.

13. The system as claimed in claim 12, characterized in that said function for calculating the start of the protection zone consists in searching through the sectors of said transport means (CD-R1) for a sector of said first part that contains start of protection zone information for said part and that is followed by a sector of said second part that contains the start of protection zone information for said second part, and in verifying that these conditions hold simultaneously just once and that the protection zone start found is situated at distances greater than predetermined values from the start and from the end of the main track.

14. The system as claimed in any one of the preceding claims, characterized in that said transport means (CD-R1) and said storage means (CD-R2, CD-R3) are recordable optical disks.

15. A process for protection against the copying of information recorded on a protected optical disk of the type comprising at least one main spiral track onto which are burnt information marks laid out in sectors whose addresses are substantially sequential along the track, and a protection zone (ZDP) having two parts of substantially the same size, each including a series of sectors designated by identical addresses for each part, each sector of the protection zone including identification information characteristic of the part to which it belongs and one of the parts at least belonging to said main track, said process being characterized in that it consists in creating a protection file on the basis of software protection elements selected during the creation of said file and in recording said file in the protection zone of the disk.

16. The process as claimed in claim 15, characterized in that a protection element is constructed by the variable positioning of the part identifying information and in that said process correspondingly includes a step consisting in calculating the position of the identifying information inside the sector considered, as a function of the relative position of the sector in the protection zone and of the absolute position of the start of said zone.

17. The process as claimed in one of claims 15 and 16, characterized in that a protection element is constructed by the concealing of data chosen by a publisher creating said protection file and in that said process correspondingly includes steps of:
transforming the data chosen according to a given transformation law;
implanting the data obtained according to said transformation law in a distributed manner between the two parts of said protection zone.

18. The process as claimed in claim 17, characterized in that said step for transforming the chosen data comprises the steps of:
drawing a random number k;
subdividing, for each register consisting of two associated sectors of the two parts of the protection zone, the data according to matrices of size k plus a surplus, if any;
permuting the rows with the columns in each matrix while preserving the surplus, if any, as is.

19. The process as claimed in any one of claims 15 to 18, characterized in that a protection element is constructed by the implantation of decoys into the two associated sectors of a register of the protection zone in such a way that the reading of just a single part of the protection zone induces apparently correct but different functioning of the application recorded on the protected disk.

20. The process as claimed in any one of claims 15 to 19, characterized in that a protection element is constructed by the enciphering/deciphering of data according to a level of security chosen by a publisher of an application creating said protection file for this application and in that said process correspondingly includes the steps of:
choosing a security level for said enciphering/deciphering;
randomly choosing, from the selected security level, an enciphering/deciphering algorithm;
creating a private key associated with said algorithm;
storing said algorithm and said private key in an enciphering module contained in the two associated sectors of a register of said protection zone;
creating, under the control of the publisher, an application package key on the basis of the data of said module;
enciphering/deciphering the data on the basis of the elements of said module and of said associated application package key.

21. The process according to any one of claims 15 to 20, characterized in that a protection element is constructed by anti-intrusion measures and in that said process correspondingly includes at least one of the following steps:
detecting on request the presence of a debugger;
verifying the integrity of codes of said protection file by calculating CRCs;
verifying a signature of the disk on data stored in said protection zone;
verifying the execution time of predetermined steps of said process;
triggering counter-measures when at least one of said steps leads to the detection of an anomaly.

22. The process as claimed in claim 21, characterized in that said step of verifying the integrity of codes comprises:
the calculation of CRCs of software components during the creation of said protection file;
the verification of said CRCs during the loading of said components.

23. The process as claimed in one of claims 21 and 22, characterized in that said step of verifying a signature comprises:
the calculation of a CRC of the useful data of a sector during the creation of said protection file;
the verification of the value of said CRC during the use of said sector.

24. The process as claimed in any one of claims 21 to 23, characterized in that said counter-measures comprise at least one of the following measures:
placing of the user system of said disk in an unstable state when the presence of a debugger is detected during initialization or during said signature verification step;
placing of said user system of said disk in a critical state when the presence of a debugger is detected during said step of detection on request;
placing of said user system of said disk in a disabled state when an anomaly is detected during said steps of verifying the integrity of codes and/or of verifying the execution time.

25. The process as claimed in claim 24, characterized in that the placing in an unstable state consists in the data requested by the system not being read or being modified without warning.

26. The process as claimed in one of claims 24 and 25, characterized in that the placing in a critical state consists in any subsequent reading from the protection zone causing the system to halt without notice.

27. The process as claimed in any one of claims 24 to 26, characterized in that the placing in a disabled state consists in a disabling without information or notice of the system.
